(19) United States
(12) Patent Application Publication
(10) Pub. No.: US 2003/0140010 A1
(43) Pub. Date: Jul. 24, 2003

(54) Method and apparatus for routing signed messages

(76) Inventors: Andrew J. Patterson, Chatham (GB); Craig P. McMillan, Frekhaug (NO)

Correspondence Address: B. Noel Kivlin, Meyertons, Hood, Kivlin, Kowert & Goetzel, P.C., P. O. Box 398, Austin, TX, 78767-0398, US

(21) Appl. No.: 10/282,762

(22) Filed: Oct. 29, 2002

(30) Foreign Application Priority Data
Oct. 31, 2001 (GB) 0126117.1

(51) Int. Cl. G06F 17/60

(52) U.S. Cl. 705/76

(57) ABSTRACT

A mechanism and method are provided for sending a message digitally signed by a plurality of signatories to one or more recipients. The mechanism can be provided by a mail client or a plug-in for a mail client. A first co-signatory generates an initial message. The initial message includes a content section and a routing section. The routing section can include a signatory field that identifies at least one co-signatory and a recipient field that identifies at least one recipient. The message is digitally signed so as to cover the content section and the routing section. The signatory field in the routing section is used to route the message in turn to each identified co-signatory for signature. The recipient field in the routing section is then used to route the message signed by the plurality of signatories to each identified recipient.

### BACKGROUND OF THE INVENTION

The invention relates to an apparatus and method for signing messages.

There are many circumstances when conducting business over a computer network when it is necessary or desirable to verify the authenticity of a message, for example an e-mail message, and to confirm that the apparent sender is the true sender of the message. This is a non-trivial technical problem as the recipient of the message will typically not have direct personal contact with the sender of the message and merely providing a password or the like will not prevent someone else sending the message or tampering with the message if they know the password.

In order to address this need, the concept of a digital signature has been developed. A digital signature is a verifiable digital encoding that uniquely identifies a sender and can wrap a message or information provided by the sender. Once a message or information has been signed, it cannot be tampered with without the tampering being evident. An example of a protocol for signing messages is provided in the IETF S/MIME Standard RFC 2633.

There are also situations where a number of parties may wish to sign a message. An example of this might be where multiple persons or bodies need to authorise a transaction before that transaction may take place.

The IETF S/MIME Standard RFC 2633 does allow for multiple signatures. However, the only current way for multiple sending parties to sign a message is to send the message from signatory to signatory. Each signatory signs in turn, before the message is sent to the intended recipient with all the signatures nested in the order in which the signatories signed the message. This way of providing multiple signatures requires each signatory manually to forward the message between in an agreed order. In other words, the order in which the signing needs to occur has to be understood by each of the signatories, and then they are each responsible for their part in ensuring that the appropriate routing occurs. The resulting message sent to the recipient has the original content wrapped in multiple layers of signatures.

### SUMMARY OF THE INVENTION

Various aspects of the invention are set out in the accompanying claims.

An aspect of the invention provides a method of routing a message that includes a content section and a routing section, wherein the routing section defines an order of routing the message via at least one co-signatory to at least one recipient and the message, including the routing section, is digitally signed by a first signatory. The method comprises a mail client of a said co-signatory receiving the message and the mail client controlling routing of the message according to the content of the signed routing section.

Another aspect of the invention provides a method of sending a message digitally signed by a plurality of signatories to at least one recipient. The method includes generating a message having a content section and a routing section. The routing section includes a signatory field that identifies at least one co-signatory and a recipient field that identifies at least one recipient. The method further includes digitally signing the message so as to cover the content section and the routing section. The signatory field in the routing section is used to route the message in turn to each identified co-signatory for signature. The recipient field in the routing section is then used to route the message signed by the plurality of signatories to each identified recipient.

The use of a routing section in the message that is signed along with the content section means that the routing of the message can be predefined in a secure manner such that the routing cannot be changed following generation of the message without this being detectable. This secure routing information can further be used automatically to control the routing of the message.

By adding a respective digital signature for each co-signatory that covers the content section, the routing section and all previous signatures, each co-signatory can sign in a manner that confirms that any previous co-signatory had already signed.

The verification of the information in the message and the signing can be performed in response to a human user input. In this case, the adding of a respective digital signature for a co-signatory can be performed in response to input by the user. However, it is also possible that a co-signatory could be a machine (for example a computer or other network connected equipment) or a computer program that is operable to verify the information in a message it receives and then to add an appropriate signature before passing the message to the next signatory or to the intended recipient.

Similarly, the initial generation of the message and the initial digital signing that covers the content section and the routing section of the message can be performed in response to human user input where the first signatory is a human being. However, it is also possible that the initial, or first, signatory could be a machine (for example a computer or other network connected equipment) or a computer program that is operable to generate the initial message and to add an appropriate initial signature before passing the message to a co-signatory.

The routing of the message includes automatically setting TO and FROM fields in a message header from the content of the secure routing section. The TO and FROM fields are the TO and FROM fields conventionally provided in an electronic message (e.g. an e-mail message) to provide routing via a network. The TO and FROM fields change each time the message is forwarded, as opposed to the secure routing information formed from the signatory and recipient fields which does not change.

The signatory field defines an order in which co-signatories are to sign the message. This could be in the form of a simple list, or could be in the form of a more complex data structure defining the way in which the signing of the message is to be performed.

Another aspect of the invention provides a mechanism for generating a message to be signed digitally by a plurality of signatories. The mechanism includes a message generator that is operable to generate a message having a content section and a routing section. The routing section comprises a signatory field that identifies at least one co-signatory and a recipient field that identifies at least one recipient. A message signer is operable digitally to sign the message so as to cover the content section and the routing section. A message router is configured to use the signatory field in the routing section to route the message to a co-signatory identified for signature.

The mechanism thus enables a message to be generated that includes a routing section that is signed along with the content section. This means that the routing of the message can be predefined in a secure manner such that the routing cannot be changed following generation of the message without this being detectable. This secure routing information can further be used automatically to control the routing of the message.

Where a first signatory is a human user, the message generator can be responsive to user input to generate the message and the message signer can be responsive to user input to sign the message. The message router can then be operable to route the message automatically in response to user input by a signatory. The message router can further be operable automatically to set TO and FROM fields in a message header from the signatory field and the recipient field of the routing section.

The mechanism can further comprise a message receiver that is operable to identify a received message as a message requiring a plurality of signatories. The message signer can be further operable to add a digital signature for a co-signatory to the message that covers the content section, the routing section and all previous signatures. The message router can further operable to route the message to a further signatory that has not yet signed where there is one, or otherwise to route the message signed by the plurality of signatories to each recipient identified in the recipient field of the routing section.

The message signer can be operable to add a digital signature for a co-signatory in response to user input by the co-signatory. The message router can then be operable to route the message automatically in response to user input by a signatory. The message router can be operable automatically to set TO and FROM fields in a message header from the content of the signatory field and the recipient field of the routing section and the FROM field in a message header of the received message. As the FROM field in a message header indicates from whom the message was received and as the content of the signatory field and the recipient field indicates the order in which the message is to be forwarded, the message router can determine to whom the message should now be forwarded.

A further aspect of the invention provides a computer program including computer program code operable to provide a mechanism as described above. The computer program code can be carried by a carrier medium.

A computer system can include a mechanism as described above, for example in the form of computer program including computer program code for implementing the mechanism.

The invention also provides an electronic message signed digitally by a plurality of signatories and routed to at least one recipient by a method as described above. The message includes: a message header portion having TO and FROM fields; a secure portion including a routing section comprising a signatory field that identifies at least one co-signatory and a recipient field that identifies at least one recipient and a content section that holds the message content; and a signature portion holding a plurality of digital signatures that digitally sign at least the content section and the routing section.

Each digital signature can covers the content section, the routing section and any earlier generated digital signature. The message header can include a FROM field identifying at least the last signatory and/or a TO field identifying at least one recipient. Borders can be provided between respective message portions. The electronic message can be in the form of an e-mail message.

An embodiment of the invention provides a mail client that is operable to route an electronic message initiated by a first signatory and having a content section and a routing section, the routing section comprising a signatory field that identifies at least one co-signatory and a recipient field that identifies at least one recipient, the message being digitally signed so as to cover the content section and the routing section, the mail client using the signatory field and the recipient field in the routing section to control routing of the message.

### BRIEF DESCRIPTION OF THE DRAWINGS

Embodiments of the present invention will be described hereinafter, by way of example only, with reference to the accompanying drawings in which like reference signs relate to like elements and in which:

FIG. 1 is a schematic representation of an example of a network environment in which an embodiment of the invention may be implemented;

FIG. 2 is a schematic representation of a computer on which an embodiment of the invention may be implemented;

FIG. 3 is a schematic representation of a computer on which an embodiment of the invention may be implemented;

FIG. 4 represents an example of a message structure used in an exemplary embodiment of the invention;

FIG. 5 is a flow diagram illustrating the generation by an embodiment of the invention of a message to be signed by a plurality of signatories;

FIG. 6 illustrates an example of a message output by the method of FIG. 5;

FIG. 7 is a flow diagram further illustrating further steps of the method of FIG. 5 subsequent to those illustrated in that Figure;

FIGS. 8 and 9 illustrate how the message of FIG. 6 is modified during various passes of the further steps of FIG. 7;

FIG. 10 illustrates an illustrative example of a possible messaging environment;

FIG. 11 is a flow diagram illustrating the operation of a message creation mechanism; and

FIG. 12 is a flow diagram illustrating the operation of a message receipt and validation mechanism.

### DESCRIPTION OF PARTICULAR EMBODIMENTS

A particular embodiment of the invention will be described hereinafter in the context of e-mail messaging over a network such as the Internet, a corporate intranet, or the like.

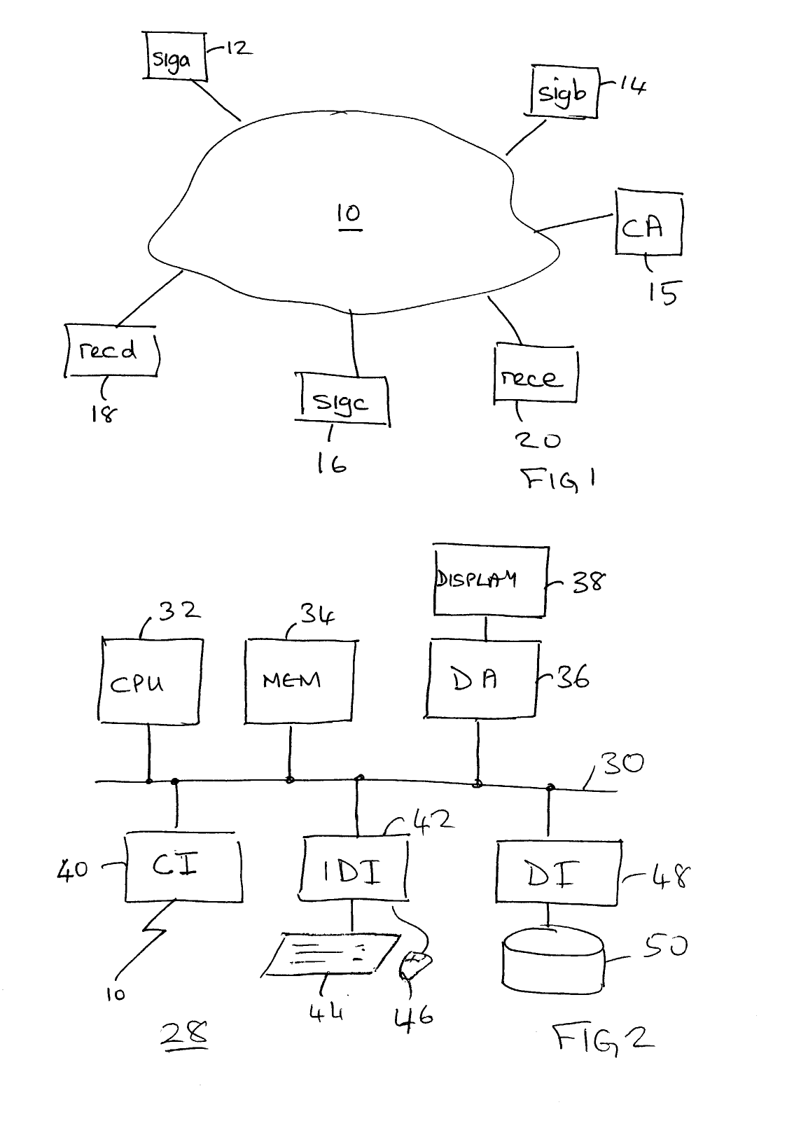

FIG. 1 illustrates a network (for example, the Internet) 10, to which a number of computer stations 12, 14, 16, 18 and 20 are connected. In this example, it is assumed that each computer station supports one or more respective e-mail domains and has at least one user at that domain. A user siga at domain doma is located at a first computer station 12. A user sigb at domain domb is located at a second computer station 14. A user sigc at domain domc is located at a third computer station 16. A user recd at domain domd is located at a fourth computer station 18. A user rece at domain dome is located at a fifth computer station 12. In this exemplary embodiment it is assumed that users siga, sigb and sigc are to co-sign a message to be sent to users recd and rece. In the following, users siga, sigb and sigc will be described as signatories (or co-signatories) and users recd and rece will be described as recipients.

The arrangement shown in FIG. 1 is a schematic one for illustrative purposes only. It will be appreciated from the following that the invention is not limited to such a configuration. For example, one or more users at each of one or more domains can be located at each of one or more computer locations in an embodiment of the invention. Similarly, any desired number of signatories can sign a message and send this to any number of recipients. Also, a user may be both a signatory and a recipient. Also shown in FIG. 1 is a Certification Authority (CA) 15.

In the present instance, it is assumed that the signatories and recipients are human beings. However, they can equally be machines or computer programs that are programmed to provide the functions of a signatory of recipient. In the present context, therefore, a “user” need not be a human user, but can be a machine, computer program etc.

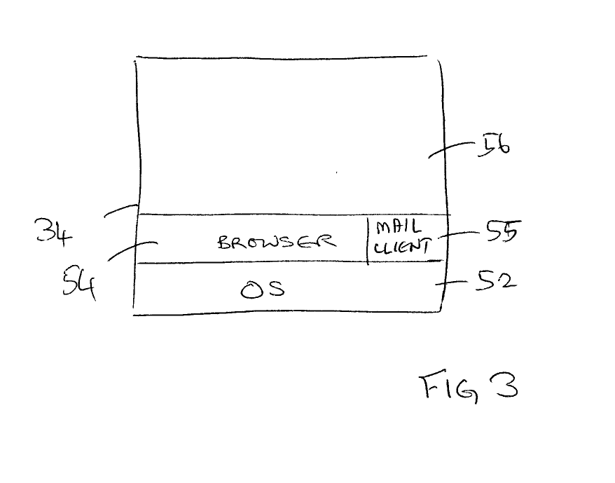

FIG. 2 is a schematic block diagram illustrating an exemplary configuration of a computer station 28 forming, for example, one of the computer stations 12, 14, 16, 18 and 20 of FIG. 1. The computer station 28 includes a bus 30 to which a number of units are connected. A microprocessor (CPU) 32 is connected to the bus 30. Main memory 34 for holding computer programs and data is also connected to the bus 30 and is accessible to the processor. A display adapter 36 connects a display 38 to the bus 30. A communications interface 40, for example a network interface and/or a telephonic interface such as a modem, ISDN or optical interface, enables the computer workstation 28 to be connected to the network 10. An input device interface 42 connects one or more input devices, for example a keyboard 44 and a mouse 46, to the bus 30. One or more drive interfaces 48 provide access to one or more media drives 50 such as a hard disk, a CD-ROM, a DVD, a tape drive, etc. Further interfaces, not shown, for example for connection of a printer (not shown), may also be provided. Indeed, it will be appreciated that FIG. 2 provides merely an exemplary overview of a possible configuration of a computer station 28, and that each computer station can have any conventional form.

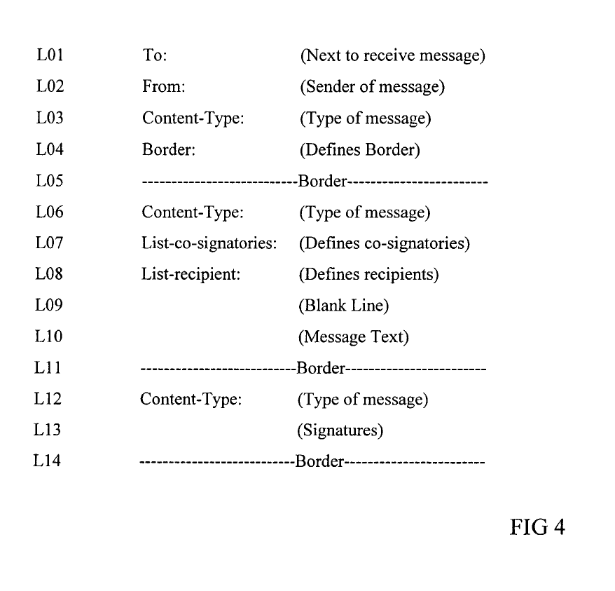

FIG. 3 is a schematic representation of software elements held in the memory 34 of the computer station 28 of FIG. 2 during operation. FIG. 3 illustrates the operating system (OS) and a browser 54, for example a web browser application such as the Netscape Navigator browser, or another such application. A mail client 55 is operable to control the sending and receipt of messages, for example e-mail messages. The mail client 55 can be separate from the browser 54, or can be integrated with or form part of the browser 54. Also shown is a general memory space 56 for user applications and data. The operating system, browser and mail client are typically held in the media drive(s) 50, and are loaded into the memory 34 when the corresponding software components are initiated.

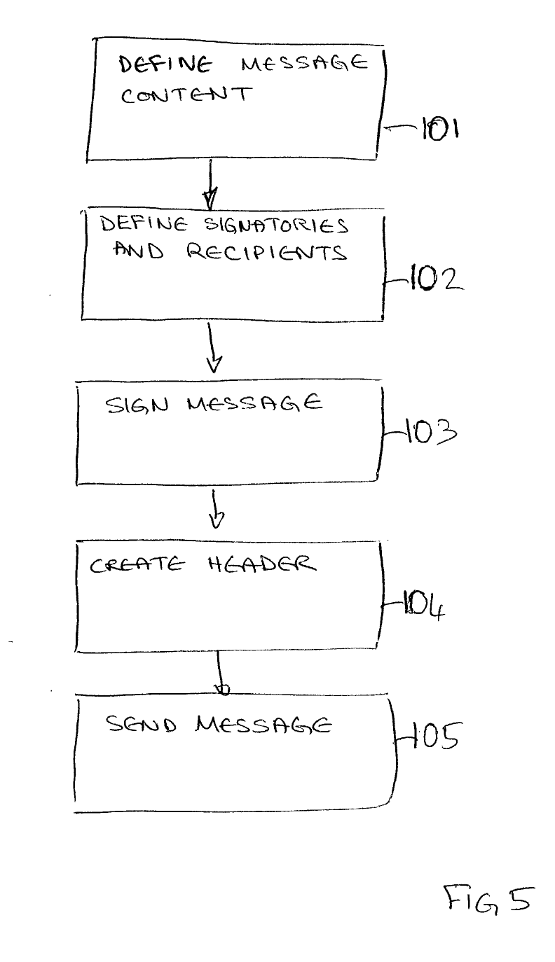

FIG. 4 illustrates a general structure for a message used in an embodiment of the present invention. This message is configured to be compatible with existing e-mail messages, for example in accordance with the Secure/Multipurpose Internet Mail Extension (S/MIME) standards, for example the RSA Data Security, Inc standard PKCS#7 (Further information is available in, for example, RFC 2311, RFC 2312 and RFC 2315, that can be accessed, for example at http://www.imc.org/rfcxxxx, where xxxx is the appropriate rfc number). The message includes a structure with different portions, with each portion being identified by a content type identifier, and with the portions being separated by a border, defined in a first, or header portion. A digital (cryptographic) signature is generally employed as well. Those skilled in the art will appreciate that FIG. 4 provides merely an outline, or overview of a possible message and that the message will typically contain much more detail than is illustrated in FIG. 4.

It should be noted that the line designations L01-L14 shown do not actually form part of the message structure, but are added solely for the purposes of identifying the lines in the following description.

As illustrated in FIG. 4, a header is formed by lines L01 to L04, a secure portion of the message comprises lines L06 to L10, and a signature portion is formed by lines L12 and L13. Line L05 is a border separating the header and secure portions of the message, line L11 is a border separating the secure portion of the message and the signature portion of the message, and line L14 is a border signifying the end of the signature portion of the message. This example shows a so-called “clear-signed message” in the S/MIME terminology, for ease of demonstration. Alternative message structures can also be used.

Line L01 is a TO field for the message which identifies the destination(s) of the message. Line L02 is a FROM field which identifies the signatory(s) of the message.

Line L03 identifies the content type of the message as a whole. For this particular type of message, a type designation “multipart/signed message” is allocated. Line L04 is a border field defining the border used to separate the various portions of the message as mentioned earlier.

Line L05 shows the border (as defined by line L04). The form of the border can be freely chosen, as long as it provides a string that is not otherwise to be found in the message.

Line L06 defines the content type for the information within the secure portion of the message. Line L07 is a co-signatory field holding a list or set of the co-signatories that are to sign the message. The co-signatories in the signatory field are defined by the initiator of the message. Line L08 is a recipient field holding the recipient(s) of the message when this has been signed by the plurality of co-signatories. The recipients in the recipient field are also defined by the initiator of the message.

Line L09 is a blank line that separates the headers from the actual message text. The message text is contained line L10 of the message. Within this secure portion of the message, the list of signatories and recipients in lines L07 and L08 can be defined as a routing section, and the message text in line L10 can be defined as a content section of the secure portion of the message.

Line L11 is a border portion using the same string as line L05 to separate the secure portion of the message from the signature portion of that message.

Line L12 identifies the content type for the signature portion. Line L13 contains the signatures of the signatories as the message is signed by those signatories. Line L14 is also a border using the same string as lines L05 and L11.

The function of the various portions of the message type illustrated in FIG. 4 will become clearer from the following description. However, the important aspect of the message format shown in FIG. 4 is that the co-signatories and recipients are identified within the secure portion of the message, as well as the message content (message text).

In the example the list of signatories and recipients has been added to the signed content as additional RFC822 MIME headers, which makes for easily readable examples. Other representations are of course possible. For instance, the same lists can be encoded as authenticatedAttributes within the PKCS#7 signature, or some other format appropriate to the signing scheme used. It will be noted, however, that the list of signatories and recipients is protected from modification by the signature.

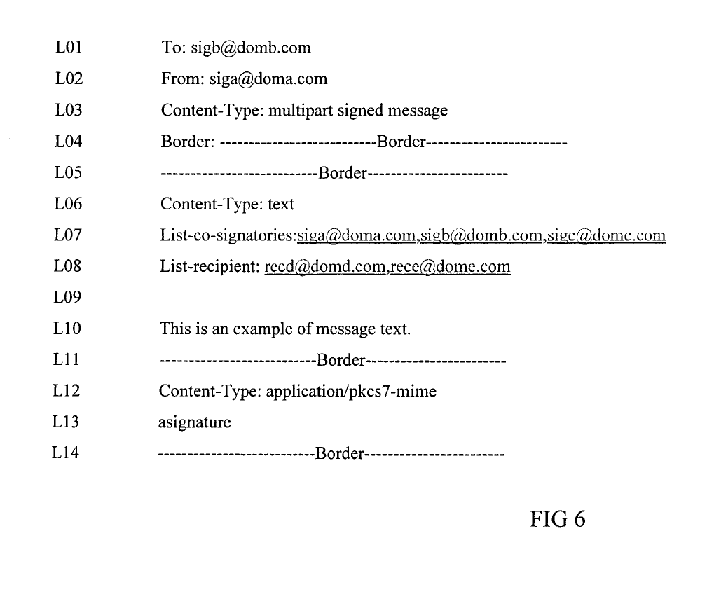

FIG. 5 is a flow diagram illustrating the generation of a message type shown in FIG. 4.

In step 101, the user, or initiator of the message, defines the message content (for example, a message text that reads “this is an example of message text”).

In step 102, the initiator of the message also provides, in a list field, identifiers of appropriate keys (e.g., a public/private key pair) for the participants to use for signing. This can be done directly using, for example, the issuer and serial number of a certificate containing an appropriate public key, or indirectly with an identifier such as an e-mail address.

In the present example, this is achieved in step 102 using e-mail addresses. Thus, in step 102, the initiator of the message (user siga@doma.com) identifies the co-signatories and recipients using their e-mail addresses. In the present example, the co-signatories are the initiator (siga@doma.com) and sigb@domb.com and sigc@domc.com. This message needs to be signed by each of siga, sigb and sigc. The recipients are recd@domd.com and rece@dome.com. The co-signatories are entered into the signatory field at line L07 in the message and then the recipients are entered into the recipients field at line L08 in the message.

In step 103, the user initiates the signing of the message, and the mail client 55 is operable to form a signature based on the secure portion (L06-L10) of the message. The signature is entered at L13 in the message.

In step 104, the mail client 55 then generates the header information for the message, including identifying the destination of the message and the sender of the message. The mail client knows that it is the mail client for the user siga, and accordingly it enters siga@doma.com in the FROM field of the header. It knows from the signatory field that there are still signatories to sign, namely sigb@domb.com and sigc@domc.com. Accordingly, it enters the first of the remaining co-signatories into the TO field of the header.

In step 105, it dispatches the message to the destination identified in the TO field.

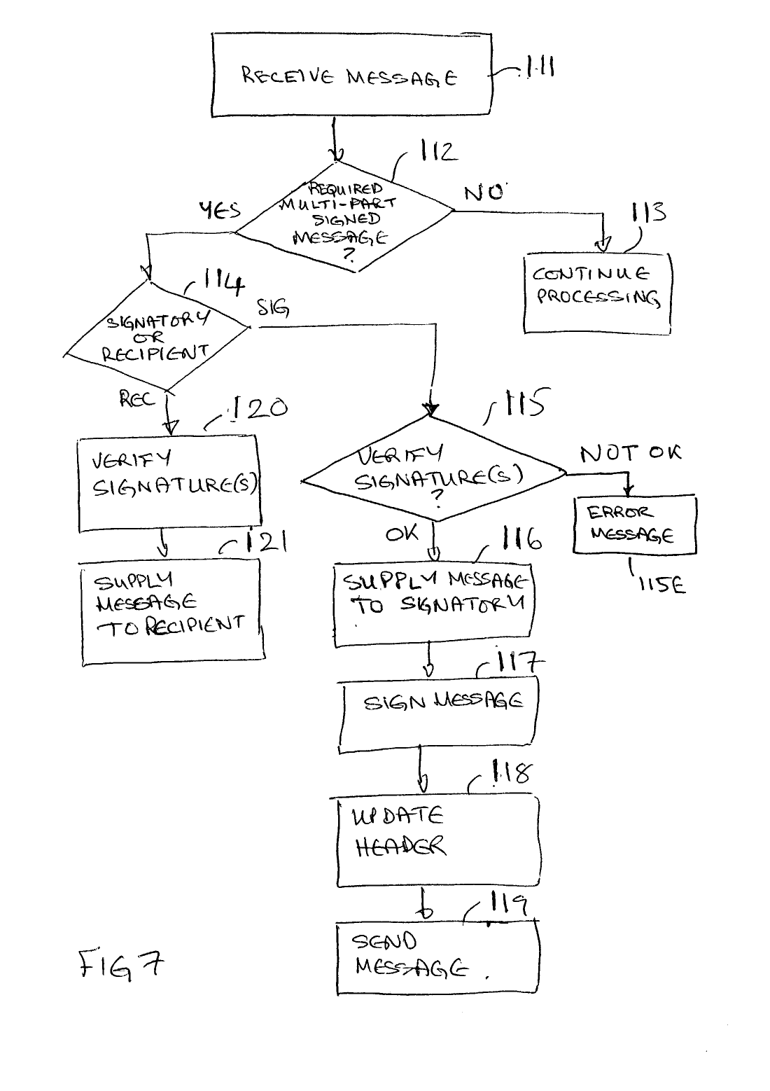

FIG. 6 illustrates the message in the form to be sent in step 105. It will be appreciated that the message as shown in FIG. 6 is for illustrative purposes only, and therefore only illustrates the general format of the message.

In FIG. 6, line L0 1 contains the TO field identifying sigb@domb.com as the destination of the message. Line L02 contains the FROM field identifying siga@doma.com as the sender of the message. Line L03 identifies the content type as a multipart signed message. Line L04 defines the border format. Line L05 is an instance of the border separating the header from the secure portion of the message. Line L06 identifies the content type of the secure portion of the message (here text).

Line L07 identifies the co-signatories, including siga@doma.com, sigb@domb.com and sigc@domc.com. Line L08 identifies the recipients, in the present instance recd@domd.com and rece@dome.com. Line L09 is a blank line. Line L10 includes the message text “this is an example of message text”. Line L11 is a border separating the secure portion of the message from the signature portion of the message. Line L12 illustrates the content type of the signature portion (here application/pkcs7-mime). Line 13 includes the digital signature of user siga (here represented by the string “asignature”). Line 14 is a border defining the end of the message.

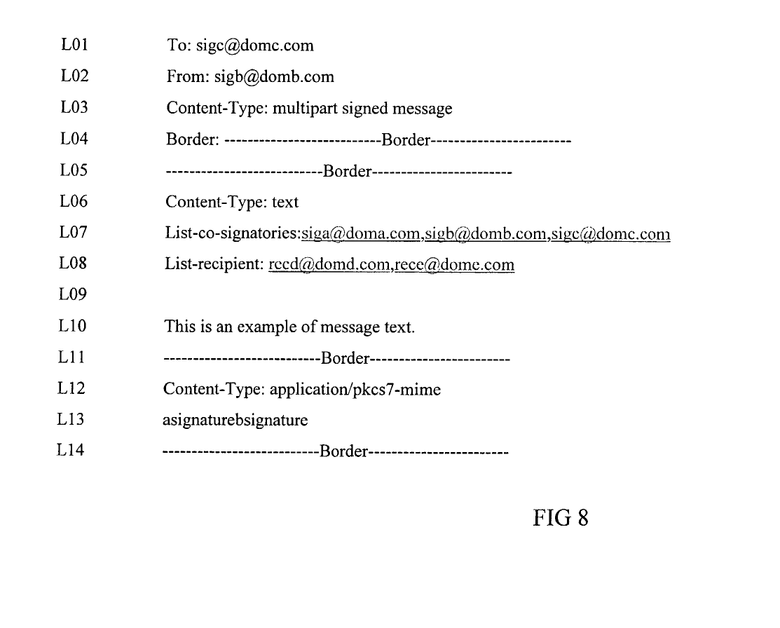

FIG. 7 illustrates the operation of a mail client on receiving a message in an embodiment of the present invention.

In step 111 the message is received. In step 112 the content type portion at line L03 of the message is investigated to determine whether the content type is the appropriate message type, herein described as a “multipart signed message”. If it is not, then processing is performed by appropriate conventional aspects of the mail client in step 113.

If, however, it is determined in step 112 that the message is of the aforementioned “multipart signed message” type, then in step 114, the mail client is operable to determine whether the mail client that has received the message is a signatory or a recipient. This can be determined by the mail client by comparing its own security credentials with the lists of co-signatories and recipients in the secure portion of the message.

If, in step 114, the mail client determines that it is acting for a signatory for the message, then in step 115 the signature or signatures in the signatory portion (line L13) are verified. If the verification fails, then an appropriate error message is provided 115E. Otherwise, in step 116, the message is supplied to the signatory for the signatory to analyze.

Assuming the signatory approves the message, in step 117, the message is signed by adding the signature for the current signatory. The signature is computed to include at least the secure portion of the message, and preferably also any signature already present in the signature portion.

In step 118, the TO and FROM fields are updated in the header portion so that the two fields then point to the next co-signatory in the signatory field (if there is one) or alternatively to the recipients field if all signatories have already signed.

In step 119, the message is then sent to the destination(s) identified in the TO field.

If it is determined in step 114 that the mail client is acting for a recipient of the message, then in step 120 the signatures are verified. If the verification is not positive, then an appropriate error message is generated. Otherwise, in step 121, the message is supplied to the recipient.

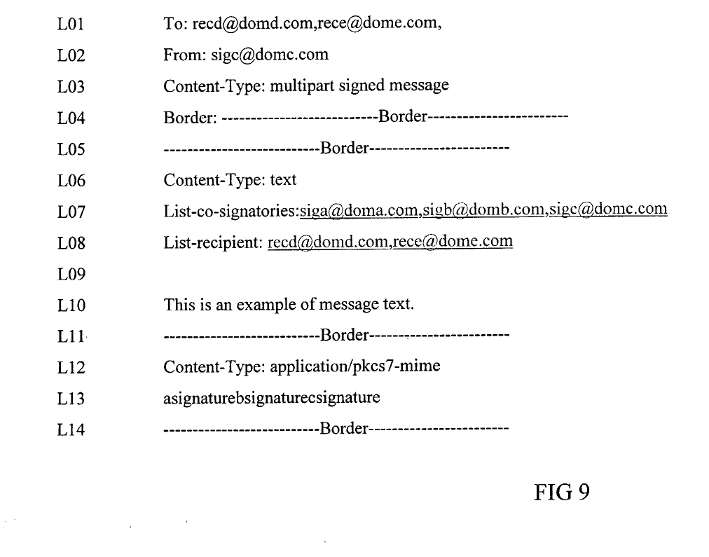

FIGS. 8 and 9 illustrate how the message of FIG. 6 is modified in response to the user sigb signing the message and in response, subsequently, to the user sigc signing the message.

FIG. 8 illustrates the modified message output in step 119 following signing by the user sigb.

When the user sigb receives the message of FIG. 6, it will be identified as a multipart signed message in step 112 of FIG. 7 and the mail client will identify that sigb is a signatory in step 114. Assuming the signature (represented by asignature) is valid and user sigb signs the message, then the signature (represented by bsignature) for sigb is added to the signature portion at line L13. To better ensure security, the signature (represented by bsignature) covers the secure portion of the text (line L06 to L10) and the signature (represented by asignature) already present in the message as received. In step 118, the mail client will identify that the message was received from siga (from the FROM field of the received message). The mail client will also know that it represents sigb. Consequently, it will identify from the signatory field that the message then needs to be forwarded to the user sigc@domc.com. Accordingly, the mail client for the user sigb will insert sigb in the FROM field of the header at line L02 and will insert sigc@domc.com in the TO field at line L01 of the header.

FIG. 9 illustrates the modified message output in step 119 following signing by the user sigc.

When the user sigc receives the message of FIG. 6, it will be identified as a multipart signed message in step 112 of FIG. 7 and the mail client will identify that sigc is a signatory in step 114. Assuming the signatures (represented by asignature and bsignature) verify correctly and user sigc signs the message, then the signature (represented by csignature) for sigc is added to the signature portion at line L13. In the preferred embodiment of the invention, the signature (represented by csignature) covers the secure portion of the text (line L06 to L10) and the signatures (represented by asignature and bsignature) already present in the message as received. In step 118, the mail client will identify that the message was received from sigb (from the FROM field of the received message) and will know that it represents sigc whereby it will identify from the co-signatories field that the message sibc is the last signatory. Accordingly, it will determine from the recipient field that the message then needs to be sent to the recipients recd@domd.com and rece@dome.com. Accordingly, the mail client for the user sigc will insert sigc in the FROM field of the header at line L02 and will insert recd@domd.com and rece@dome.com in the TO field at line L01 of the header.

In the present example, the signatory field is a simple list identifying various users in order who are to be defined as signatories and/or recipients. However, as an alternative, the co-signatories and recipients can be identified using a structured definition for defining a logical structure for signing. Thus, for example, it may be desired that a particular user or group of users only signs in respect of another user or group of users and will not generally sign all users in the message. Thus, for example, within the list of signatories logical functions (for example Boolean logic functions such as AND, OR, NOT) can also be included. A possible format for a set of signatures can use a syntax such as is illustrated in the example immediately below:

sigexpr::=sig|sig,sigexpr

sig::=id|(sigexpr)id

id::=email|x.509 issuer+s/n|name

“sigexpr” is a signature expression, and defines lists of signature identifiers and countersignature identifiers. “sig” is either a signature identifier or a counter signature identifier of a sigexpr. “id” is an identifier used to determine the keys that will be used to sign and verify signatures and counter signatures. In this case an e-mail address, a description of an X.509 certificate, or an application specific name are permissible.

There now follows some examples using simple names instead of e-mail addresses or certificate details. In these examples, it is assumed that the signatories can be formed by one or more clients of one or more banks (e.g., client, clienta, clientb) and the bank(s) (e.g., bank, banka, bankb).

| | |
|---|---|
| (client)bank | a bank countersigns a client's signature |
| (clienta, clientb)bank | a bank countersigns two clients |
| | signatures |
| ((clienta, clientb)banka)bankb | bankb countersigns banka's |
| | countersignature of the two client |
| | signatures |
| (clienta, elientb)banka, (clienta, clientb)bankb | banka and bankb separately countersign |
| | clienta and clientb signatures |

In this syntax, the signatures within parentheses are signed by the entity identified to the right of the close parenthesis. It will be appreciated that this syntax is not the only possible syntax for specifying sets of signatures and countersignatures.

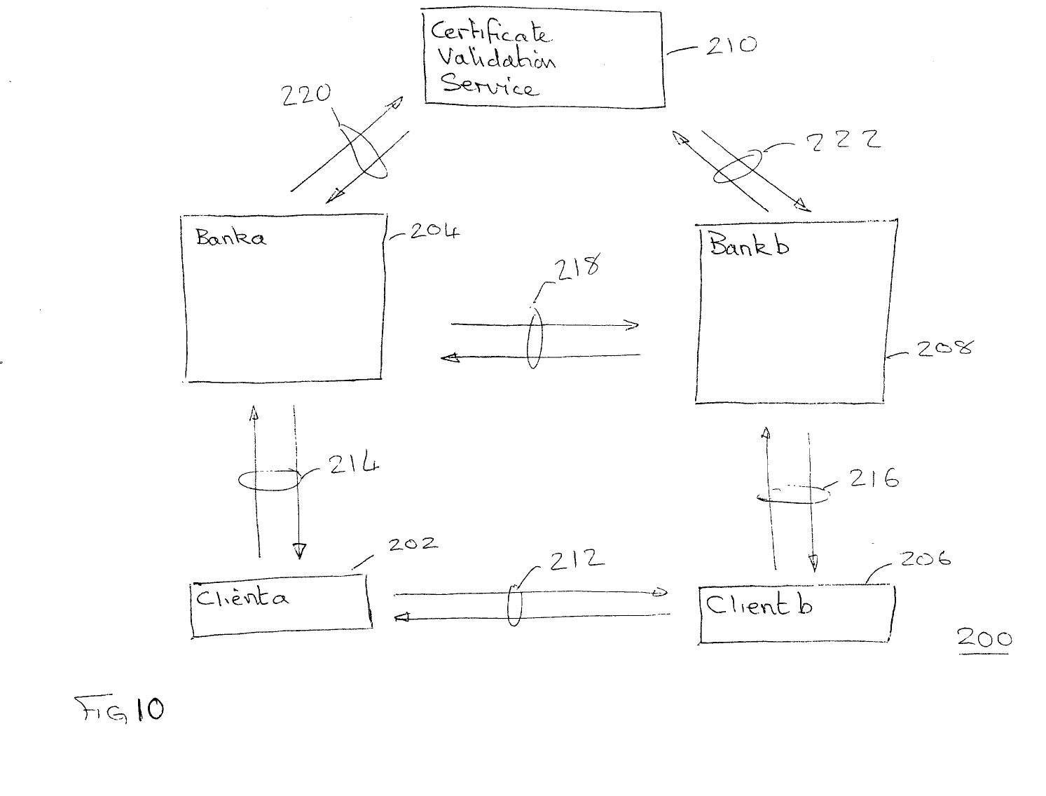

FIG. 10 is a schematic overview of a possible scenario 200 in which transactions between banks and clients of those banks are involved. A first bank customer (cleinta) 202 is a client of a first bank (banka) 204. A second bank customer (cleintb) 206 is a client of a second bank (bankb) 208. A certificate validation service 210, which can be a certification authority, or another organisation acting as an intermediary, provides certificate validation and other services to the banks 204 and 206. In such a scenario, communication can take place directly between the customers 202 and 206 (e.g. as represented by the arrows 212). Communication can also occur between the banks 204 and 206 and their respective customers 202 and 206 (e.g. as represented by the arrows 214 and 216). Communication between the banks 204 and 208 (e.g. as represented by the arrows 218) and between the banks 204 and 208 and the certificate validation service 210 (e.g. as represented by the arrows 220 and 222). The communications can be effected by e-mail using messaging as described above, for example for the arrangement and agreement of transactions between the customers 202 and 204, with the banks confirming or validating financial aspects of the transactions. It will be appreciated that the banks will have many customers such as the customers 202 and 206, and that more than two banks may cooperate in such an arrangement.

Table 1 below illustrates an example of a message using S/MIME formatting and this syntax for specifying the signature scheme. The message has been signed by user@doma.com, but not yet by userb@domb.com or user@domc.com. It is being sent to userb@domb.com for signature.

TABLE 1
Message-ID: <5666669.990636539746.JavaMail.cm102896@jcp-wts>
From: usera@doma.com
To: userb@domb.com
Subject: sign this please
Mime-Version: 1.0
Content-Type: multipart/signed; micalg=sha1;

protocoh=“application/pkcs7-signature”;
boundary=“----=_Part_1_3450840.990636511101”

------=_Part_1_3450840.990636511101
Content-Type: text/plain
Signatories: (usera@doma.com , userb@domb.com ) userc@domc.com
Recipients: usera@doma.com, userb@domb.com , userc@domc.com,

Usere@domee.com

Content-Transfer-Encoding: 7bit
Here is a message that should be signed by keys belonging to usera@doma.com, and
userb@domb.com, and then both those signatures should be countersigned by a key belonging to
userc@domc.com
When all of this has been done, the result should be distributed to all of the above, and
usere@dome.com as well.
simple
------=_Part_1_3450840.990636511101
Content-Type: application/pkcs7-signature; name=smime.p7s
Content-Transfer-Encoding: base64
Content-Disposition: attachment; filename=smime.p7s
MIIDGwYJKoZIhvcNAQcCoIIDDDCCAwgCAQExCzAJBgUrDgMCGgUAMAsGCSqGSIb3DQEH
AaCCAZ4wggGaMIIBAwIIg+ZOiqBCwD4wDQYJKoZIhvcNAQEFBQAwEjEQMA4GA1UEAxMH
bWNjcmFpZzAeFw0wMTA1MjMxNjQzMzJaFw0wMjA1MjMxNjQzMzJaMBIxEDAOBgNVBAMT
B21jY3JhaWcwgZ8wDQYJKoZIhvcNAQEBBQADgY0AMIGJAoGBAL++7UciCskBbpUn7cbuOAi
6aRdh10D/wDPjQepWulIZ9PI3XkLI7iEU8YNuga/Xmpru8ZHFfDv5uXzH70LlvpFyfe+4NCrBoa0DQ
OiflOJOEeIjLwsN/iN1D8yNx8Lf99vniYj4zznmfxJygw/Ou8gsvr+Ww3Cr186QV1NQrE1DAgMBAAE
wDQYJKoZIhvcNAQEFBQADgYEAZ/7DACDx5YDJBiQm+jddOgd17Lxdom/OkWPwTI2GYbCJJ
ZJ4XHkIHRsgid/ayuIoSSDoWyHuVSyfv3glXz0XrLT29NmJ1OaGe8Kbwi/QRBddLl4p/uv7xqnshDC
QIPwZcEYbMhyHP9LWxpgJL/qaFk006tS15i7gPqCxs75GIEwxggFFMIIBQQIbATAfMBIxEDAOB
gNVBAMTB21jY3JhaWcCCQCD5k6KoELAPjAJBgUrDgMCGgUAoHwwHAYJKoZIhvcNAQkFM
Q8XDTAxMDUyMzE2NDg0MVowHQYJKoZIhvcNAQkPMRAwDjAMBgoqhkiG9w0BCQ8CMCM
GCSqGSIb3DQEJBDEWBBTESJx3i/pgrNXMW1QQD6rBRfP50jAYBgkqhkiG9w0BCQMxCwYJK
oZIhvcNAQcBMA0GCSqGSIb3DQEBAQUABIGAvcN5huHr+vUR+D8VyOIj0QK79bnGPwHQ1DxJ
v26qaEUH6J15u/5qWvg7xmcoCkKD+R+oes3JE7iQ4SqWDQoKFsXP6jqrZCF5X53r2qLAqIbaoIkv3
MJT7KSxf/tVvxIpY+bSBEvSMV14hleh8GvuSaPpxzI1dj2+VyPSyQfmVRehAA==
------=_Part_1_3450840.990636511101--

In the present example, the FROM field only includes the last signatory to sign the documents, so that this field only shows who actually forwarded the message. However, as an alternative, the FROM field can be configured to show all of the signatories that have already signed the message. This would depart from conventional practice, but would then clearly identify who has already signed. This can be of advantage, particularly where a complex structure for signing rather than a simple list is employed.

The present invention can be implemented, for example, by specifically designing a new mail client or by modifying an existing mail client. For example, some mail clients such as the Mozilla mail client (similarly Netscape Communication Corporation's mail clients and the Qualcomm Inc.'s Eudora mail clients) support the addition of plug-in components to handle content of types which are not handled by the default distribution. If a MIME scheme is used to encode the messages as described in the above examples, then new plug-in components can be provided to parse and generate the messages described, and these components can be registered against the MIME Content-Types they service, such as the multipart/signed Content-Type in the example above. In the following, the signed messages are referred to as workflow messages.

For purposes of illustration, there follows a description of an implementation in the form of a plug-in for Qualcomm Inc.'s Eudora mail client. Details of the Eudora Extended Message Service API (EMSAPI) Version 4 can be obtained, for example, from ftp://ftp.eudora.com/eudora/developers/emsapi/emsv4a4.pdf.

The Eudora mail client defines three types of plug-ins, namely Translators, Attachers and Special Tools.

A Translator plug-in takes as input a MIME entity (a document or part thereof), and returns a transformed MIME entity. A Translator plug-in can be configured to be called at various points in the message life-cycle. The present implementation requires two Translator plug-ins.

A first Translator plug-in forms a workflow message creation plug-in to be called just before a message is queued for delivery (referred to as the Q4-completion context in the EMSAPI). Such a Translator is selected by the user clicking on an icon in a message composition window, indicating their wish to (in this case) create a workflow message.

A second Translator plug-in forms a workflow message receipt and validation plug-in, to be called just before a message is displayed to the user (referred to as the On-display context in the EMSAPI). This type of Translator is always called before messages with suitable types are displayed.

The plug-ins create and maintain three data stores. A first is a database of signing certificates and private keys, and trusted Certification Authority (CA) certificates, from which a key and associated certificate chain for signing may be selected by a user, and from which the trust status of a signature on a received message may be inferred. A second is a database of other users signing certificates, to assist in the construction of signatory lists. A third is a database of processed message identifiers, indicating whether a particular message that is a candidate for counter-signature has been processed.

The message creation plug-in is called after a user has composed a message (assuming they have selected an icon specifying that they wish to create a workflow message) and have pressed a button indicating that the message is to be sent immediately, or queued for later sending.

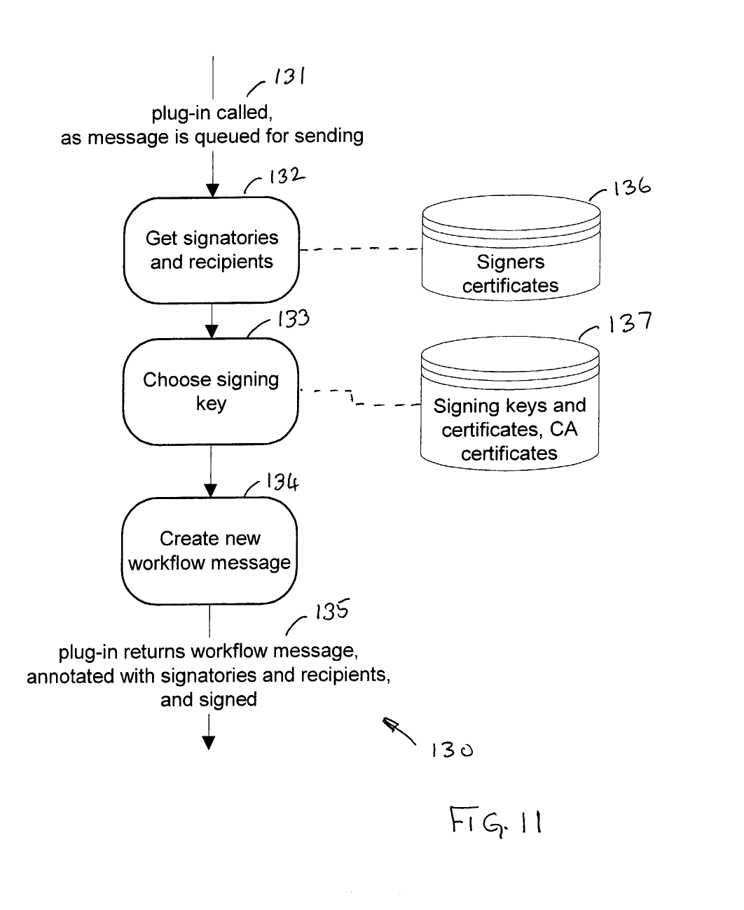

FIG. 11 is a flow diagram illustrating the functions performed by a message creation plug-in 130.

In step 131, the plug-in is called as a message is queued for sending.

In step 132, a Graphical User Interface (GUI) function prompts the user for a list of signatories, and a list of recipients. The database of other users signing certificates 136 is drawn upon to assist the user in correctly identifying the required counter-signatories private key (which will correspond to the public key in that signing certificate). In the present example, the recipients are identified by e-mail addresses (although in other examples other representations can be used).

In step 133 a GUI function prompts the user to choose a signing key, and to provide any authentication required to use the key (e.g., a password). The database of signing keys 137 and certificates is drawn upon to allow the user to select a key from a number they may have available. The keys themselves may be held on a secure token such as a smartcard or a hardware security module.

In step 134, a new workflow message can be created. A MIME entity created by the user during message composition can be formed into a workflow message MIME entity (using the list of signatories and recipients and the signing key) by the addition of suitable headers formed from the list of signatories and recipients, this then being signed using the selected signing key.

In step 135 the newly created workflow message MIME entity is returned to the mail client, whereupon it is either sent or queued for later sending, as the user has selected.

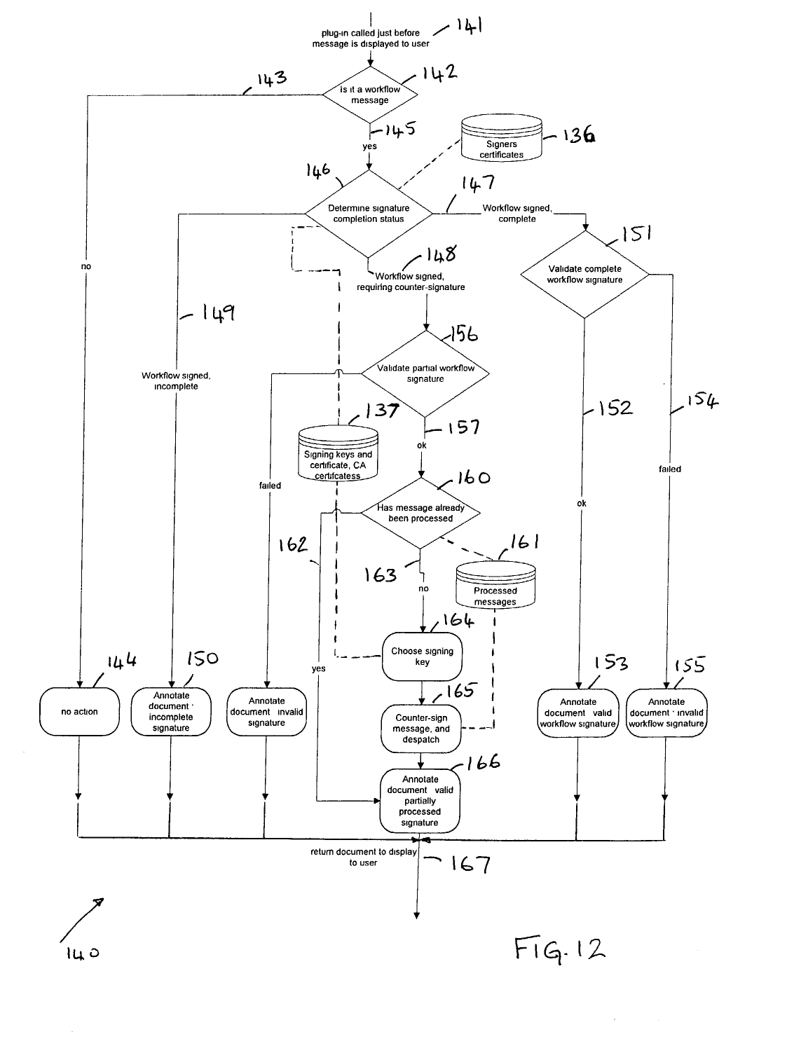

FIG. 12 illustrates the operation of an example of a message receipt and validation plug-in 140. The message receipt and validation plug-in will be called every time a message is selected for display. FIG. 12 illustrates the sequence of operations involved in displaying a stored message.

In step 141, the plug-in is called just before a message is displayed to the user.

In step 142, the message is examined to determine whether there is any workflow information present. If there is not, then path 143 is followed and no action is taken (step 144). Otherwise path 145 is taken.

Where the path 145 is taken (i.e. there is workflow information present), then in step 146, it is determined whether a workflow message has all of the required signatures. If it has all the required signatures, then the “workflow signed, complete” path 147 is followed. If not all of the required signatures are present, but the next required counter-signature can be supplied by the user, then the “workflow signed, requiring counter-signature” path 148 is followed. If not all of the required signatures are present, but the next required counter-signature cannot be supplied by the user, then the “workflow signed, incomplete” path 149 is followed and a workflow document is annotated in step 150 to indicate that the signatures are incomplete.

The database of the users signing keys and certificates 136 is used in step 146 to determine whether or not the user can supply a counter-signature in the case of a workflow document requiring further processing. The database of other users signing certificates is updated with any certificates supplied in the message which have not been encountered before, so they may be used by the user to create the signatory lists in new workflow messages.

Where the path 147 is followed, then in step 151, the signatures on the workflow document are checked, and their trust status is established. If the signatures are valid and trusted then the OK path 152 path is followed and the message is annotated in step 153 to indicate that the signatures are valid. Otherwise the failed path 154 is followed and a workflow document is annotated in step 155 to indicate that the signatures are invalid.

Where the path 148 is followed, then in step 156, the signatures on the incompletely signed workflow document are checked, and their trust status is established. If the signatures are valid and trusted, then the OK path 157 is followed. Otherwise the failed path 158 is followed and a workflow document is annotated in step 159 to indicate that the signatures are invalid.

Where the path 157 is followed, then in step 160 a database of processed messages 161 is examined, to determine whether this message has already been counter-signed. If it has, then there is no need to counter-sign again and then path 162 is followed, otherwise path 163 is followed.

Where the path 163 is followed, then in step 164 a GUI action prompts the user to select a signing key from the database of signing keys and certificates 135, and any authentication required to the key. Then, in step 165, the workflow message is countersigned, and the countersigned message is dispatched to the next counter-signatory, or to the recipients if the workflow signatures are now complete.

Following step 165, or where the path 162 is followed, in step 166 the MIME entity the user sees is annotated with text explaining the result of the process, success or failure, and details of the signatures on a workflow document.

In step 167, the workflow document (whether annotated or not) is returned to Eudora, which displays it to the user.

There has been described a mechanism and method for sending a message digitally signed by a plurality of signatories to one or more recipients. The mechanism can be implemented, for example, by a mail client, or by a plug-in for a mail client. A first co-signatory generates an initial message. The initial message includes a content section and a routing section. The routing section can include a signatory field that identifies at least one co-signatory and a recipient field that identifies at least one recipient. The message is digitally signed by a first signatory so as to cover the content section and the routing section. The signatory field in the routing section is used to route the message in turn to each identified co-signatory for signature. The recipient field in the routing section is then used to route the message signed by the plurality of signatories to each identified recipient. By signing the routing section the routing of the message can be predefined in a secure manner and can be used automatically to control the routing of the message. As the message is routed via the co-signatories, a respective digital signature is added for each co-signatory to cover the content section, the routing section and all previous signatures. The recipient thus receives a message signed by all co-signatories.

The mechanism can be implemented by a computer program that includes computer program code for controlling a computer to perform the described method. The computer program code can be provided on a carrier medium. The carrier medium can for example, be a storage medium such a solid state, optical, magneto-optical or magnetic disc or tape medium, or indeed any other form of storage medium, or can, for example, be a transmission medium such as a wireless or wired communication channel, broadcast channel or telephone line, or indeed any form of transmission medium.

As mentioned earlier, a particular embodiment of the invention has been described in the context of e-mail messaging over a network such as the Internet. It will be appreciated however, that the described embodiment is provided as an exemplary embodiment only, and that many modifications, additions, deletions and substitutions that deviate from the described embodiment may be made within the scope of the claimed invention.

1. A method of routing a message that includes a content section and a routing section, wherein the routing section defines an order of routing the message via at least one co-signatory to at least one recipient and the message, including the routing section, is digitally signed by a first signatory, the method comprising:
a mail client of said at least one co-signatory receiving the message; and
the mail client controlling routing of the message according to the content of the signed routing section.

2. The method of claim 1, further comprising:
generating the content section and the routing section; and
the initial signatory digitally signing the message, including the content section and the routing section.

3. The method of claim 1, wherein the routing section comprises a signatory field that identifies at least one co-signatory and a recipient field that identifies at least one recipient.

4. A method of sending a message digitally signed by a plurality of signatories to at least one recipient, the method comprising:
generating a message having a content section and a routing section, the routing section comprising a signatory field that identifies at least one co-signatory and a recipient field that identifies at least one recipient;
digitally signing the message so as to cover the content section and the routing section;
using the signatory field in the routing section to route the message in turn to each identified co-signatory for signature; and
using the recipient field in the routing section to route the message signed by the plurality of signatories to each identified recipient.

5. The method of claim 4, wherein the signatory field defines an order in which co-signatories are to sign the message.

6. The method of claim 1 wherein a respective digital signature is added for each co-signatory that covers the content section, the routing section and all previous signatures.

7. The method of claim 6, wherein adding a respective digital signature for a co-signatory is performed in response to user input by a respective signatory.

8. The method of claim 1 wherein the generation of the message and the digital signing that covers the content section and the routing section of the message is performed in response to user input by a first signatory.

9. The method of claim 1 wherein the routing of the message is performed automatically in response to user input by a signatory.

10. The method of claim 9, wherein the automatic routing includes automatically setting TO and FROM fields in a message header from the content of the signatory field and the recipient field of the routing section.

11. The method of claim 1 wherein the signatory field defines a structure according to which co-signatories are to sign the message.

12. The method of claim 1 wherein a plug-in for a mail client is operable to generate a message having a content section and a routing section, the routing section comprising a signatory field that identifies at least one co-signatory and a recipient field that identifies at least one recipient.

13. The method of claim 1 wherein a plug-in for a mail client is operable to evaluate a received message prior to displaying the received message to a user.

14. A mechanism for a message that includes a content section and a routing section, wherein the routing section defines an order of routing the message via at least one co-signatory to at least one recipient and the message, including the routing section, is digitally signed by a first signatory, the mechanism comprising a message router configured to route a received message according to the content of the signed routing section.

15. The mechanism of claim 14, further comprising:
a message generator that is operable to generate a said message having a content section and a routing section, the routing section comprising a signatory field that identifies at least one co-signatory and a recipient field that identifies at least one recipient; and
a message signer that is operable digitally to sign the message so as to cover the content section and the routing section.

16. The mechanism of claim 14, wherein the routing section comprising a signatory field that identifies at least one co-signatory and a recipient field that identifies at least one recipient.

17. A mechanism for generating a message to be signed digitally by a plurality of signatories, the mechanism comprising:
a message generator that is operable to generate a message having a content section and a routing section, the routing section comprising a signatory field that identifies at least one co-signatory and a recipient field that identifies at least one recipient;
a message signer that is operable digitally to sign the message so as to cover the content section and the routing section; and
a message router that is configured to use the signatory field in the routing section to route the message to a co-signatory identified for signature.

18. The mechanism of claim 17, wherein the signatory field defines an order in which co-signatories are to sign the message.

19. The mechanism of claim 15 wherein message generator is responsive to user input by a first signatory to generate the message and the message signer is responsive to user input by a first signatory to sign the message.

20. The mechanism of claim 14 wherein message router is operable to route the message automatically in response to user input by a signatory.

21. The mechanism of claim 20, wherein the message router is operable automatically to set TO and FROM fields in a message header from the signatory field and the recipient field of the routing section.

22. The mechanism of claim 14 further comprising a message receiver that is operable to identify a received message as a message requiring a plurality of signatories, the message signer being further operable to add a digital signature for a co-signatory to the message that covers the content section, the routing section and all previous signatures and the message router
being further operable to route the message to a further signatory that has not yet signed where there is one, and otherwise to route the message signed by the plurality of signatories to each recipient identified in the recipient field of the routing section.

23. The mechanism of claim 22, wherein the message signer is operable to add a digital signature for a co-signatory in response to user input by the co-signatory.

24. The mechanism of claim 14 wherein message router is operable to route the message automatically in response to user input by a signatory.

25. The mechanism of claim 24, wherein the message router is operable automatically to set TO and FROM fields in a message header from the content of the signatory field and the recipient field of the routing section and FROM fields in a message header of the received message.

26. The mechanism of claim 14 wherein the signatory field defines a structure according to which co-signatories are to sign the message.

27. The mechanism of claim 14 comprising at least one plug-in component for a mail client.

28. A mail client comprising the mechanism of claim 14

29. A computer program comprising computer program code operable to provide a mechanism according to claim 14

30. The computer program of claim 29, comprising at least one plug-in component for a mail client.

31. A computer program product comprising the computer program of claim 29, wherein the computer program code is carried by a carrier medium.

32. A computer program product comprising the computer program of claim 30, wherein the computer program code is carried by a carrier medium.

33. A computer system comprising a mechanism according to claim 14

34. A computer system comprising computer program code operable to provide a mechanism according to claim 14

35. An electronic message digitally signed by a plurality of signatories and routed to at least one recipient by the method of claim 1 the message comprising:
a message header portion having TO and FROM fields;
a secure portion including a routing section comprising a signatory field that identifies at least one co-signatory and a recipient field that identifies at least one recipient and a content section that holds the message content; and
a signature portion holding a plurality of digital signatures that digitally sign at least the content section and the routing section.

36. The electronic message of claim 35, wherein each digital signature covers the content section, the routing section and any earlier generated digital signature.

37. The electronic message of claim 35, wherein the message header includes a FROM field identifying at least the last signatory.

38. The electronic message of claim 35, wherein the message header includes a TO field identifying at least one recipient.

39. The electronic message of claim 35, comprising borders between respective message portions.

40. The electronic message of any of claim 35, wherein the electronic message is an e-mail message.

41. A method of routing a message that includes a content section and a routing section, wherein the routing section defines an order of routing the message via at least one co-signatory to at least one recipient and the message, including the routing section, is digitally signed by a first signatory, the method comprising steps for:
a mail client of said at least one co-signatory receiving the message; and
the mail client controlling routing of the message according to the content of the signed routing section.

42. A method of sending a message digitally signed by a plurality of signatories to at least one recipient, the method comprising steps for:
generating a message having a content section and a routing section, the routing section comprising a signatory field that identifies at least one co-signatory and a recipient field that identifies at least one recipient;
digitally signing the message so as to cover the content section and the routing section;
using the signatory field in the routing section to route the message in turn to each identified co-signatory for signature; and
using the recipient field in the routing section to route the message signed by the plurality of signatories to each identified recipient.

43. A mechanism for a message that includes a content section and a routing section, wherein the routing section defines an order of routing the message via at least one co-signatory to at least one recipient and the message, including the routing section, is digitally signed by a first signatory, the mechanism comprising means for routing a received message according to the content of the signed routing section.

44. A mechanism for generating a message to be signed digitally by a plurality of signatories, the mechanism comprising:
means for generating a message having a content section and a routing section, the routing section comprising a signatory field that identifies at least one co-signatory and a recipient field that identifies at least one recipient;
means for digitally signing the message so as to cover the content section and the routing section; and
means for routing the message to a co-signatory identified for signature using the signatory field in the routing section.

45. A computer program product comprising a machine or computer usable medium having machine or computer-readable program code embodied in said machine or computer usable medium operable to route a message including a content section and a routing section, said machine or computer-readable program code comprising program code for causing at least one computer to implement the method of claim 1.

46. A computer program product comprising a machine or computer usable medium having machine or computer-readable program code embodied in said machine or computer usable medium operable to send a message digitally signed by a plurality of signatories to at least one recipient, said machine or computer-readable program code comprising program code for causing at least one computer to implement the method of claim 4.
